(19) United States
(12) Patent Application Publication
(10) Pub. No.: US 2006/0104644 A1
(43) Pub. Date: May 18, 2006

(54) Mobile communication terminal, apparatus for providing wire communications to the same and method thereof

(75) Inventor: Yu Chan Kang, Seoul (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: LG Electronics Inc., Seoul (KR)

(21) Appl. No.: 11/271,560

(22) Filed: Nov. 11, 2005

(30) Foreign Application Priority Data
Nov. 15, 2004 (KR) 10-2004-0092938

(51) Int. Cl. H04B 10/00

(52) U.S. Cl. 398/130

(57) ABSTRACT

A mobile communication terminal, apparatus for providing a wire communication to the same and method thereof are disclosed, by which a wire communication can be further provided using a short range wireless communication system to be prepared for the resource shortage of a mobile communication service or a further complicated mobile communication service. The present invention includes a short-range communication module configuring an interface for a short-range communication together with a short-range communication access point and a controller setting up a wire signal path to the short-range communication module for transmission and reception of signals via the configured interface.

This application claims the benefit of the Korean Patent Application No. 10-2004-0092938, filed on Nov. 15, 2004, which is hereby incorporated by reference as if fully set forth herein.

### BACKGROUND OF THE INVENTION

1. Field of the Invention

The present invention relates to a mobile communication terminal, apparatus for providing a wire communication to the same, and method thereof. Although the present invention is suitable for a wide scope of applications, it is particularly suitable for enabling the mobile communication terminal to be provided with the wire communication.

2. Discussion of the Related Art

Generally, there are widely popularized short-range wireless communication systems such as Bluetooth and Infrared Data Association (hereinafter abbreviated IrDA). The IrDA system transmits data within a short range using infrared without a cable. The IrDA, which is provided for short-range wireless communication, is very useful in delivering document or multimedia information.

An example of using a notebook computer equipped with an IrDA communication function is explained as follows. A user configures an infrared (IR) port of the notebook computer to communicate with an IR port of a desktop computer. Once the user clicks a prescribed data transmission on the notebook computer, the corresponding data is transmitted to the desktop computer.

IR ports of an IrDA system can be easily installed at various portable devices, industrial or medical equipment, and the like, as well as desktop or notebook computers. Hence, a specific document can be printed through a printer without a separate printer cable using the IrDA system. Furthermore, a specific file can be transmitted via wireless communication. Moreover, IrDA enables a wireless payment to be made using mobile communications.

An optimized communication standard for the IrDA system has been enacted to solve the problems of compatibility between different devices, costs, short-range communications, one-to-one communications, and the like. Hence, the IrDA system is often used for wireless data communication and the next generation electronic payment system.

An IrDA interface module is generally loaded in a mobile communication terminal or a personal computer to be used for short-range communication. This is attributed to technical limitations on communication distance of IrDA interface modules and a directionality view securing matter between IrDA interface modules exchanging data with each other.

Hence, the IrDA system according to related art supports short-range communication and a limited data communication rate, but often fails in supporting remote communications such as wire communication.

Meanwhile, the currently commercialized CDMA mobile communication service or the next generation communication service to be commercialized has the following shortcomings.

First, the increase of mobile communication terminal users and the increase of transmission data volumes results in a shortage of radio resources (e.g., radio channels). Secondly, the communication services become more expensive because of the increase of mobile communication terminal users and the increase of transmission data volumes.

### SUMMARY OF THE INVENTION

Accordingly, the present invention is directed to a mobile communication terminal, apparatus for providing a wire communication to the same and method thereof that substantially obviate one or more problems due to limitations and disadvantages of the related art.

The present invention provides a mobile communication terminal, an apparatus for providing a wire communication to the same and a method thereof, by which a wire communication can be further using a short range wireless communication system to be prepared for the resource shortage of a mobile communication service or a further complicated mobile communication service.

In one embodiment of the invention, the wire communication and a wireless communication is provided using an IrDA system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, a mobile communication terminal, which supports a wire communication to a reception terminal of a wire network via an end terminal of the wire network wherein the end terminal has a short-range communication access point, according to the present invention includes a short-range communication module for configuring an interface for a short-range communication together with the short-range communication access point and a controller setting up a wire signal path to the short-range communication module for transmission and reception of signals via the configured interface.

In one embodiment, the short-range communication uses an infrared communication standard (Infrared Data Association: IrDA).

In another embodiment, the signals are formatted according to an infrared communication standard (Infrared Data Association: IrDA).

In another embodiment, the signals include control signals for setting up a service call to the reception terminal and user signals transmitted/received after a setup of the service call.

In another embodiment, an event of the wire communication to the reception terminal is notified to a serving base station supporting a wireless communication of the mobile communication terminal.

In one embodiment of the present invention, in providing a mobile communication terminal supporting a short-range communication with a wire communication to a reception terminal on a wire network, an apparatus for providing the wire communication includes a short-range communication access point having a short-range communication module that configures an interface of the short-range communication between the communication terminal and the short-range communication access point to configure the interface for transmitting and receiving prescribed signals according to the wire communication and a wire processing block establishing a service call to the reception terminal for the wire communication to connect a communication path according to the established service call to the configured interface.

In another embodiment, the short-range communication access point delivers user signals of mobile terminal received from the mobile communication terminal via the interface to the wire processing block if the communication path is connected to the interface and the short-range communication access point transmits user signals of reception terminal received from the wire processing block to the mobile communication terminal if the communication path is connected to the interface.

In another embodiment, the wire processing block transmits the user signals of mobile terminal received from the short-range communication access point to the reception terminal and wherein the wire processing block delivers the user signals of reception terminal received from the reception terminal to the short-range communication access point.

In another embodiment, the apparatus for providing the wire communication is installed at an end terminal of the wire network. More preferably, the end terminal includes one selected from the group consisting of a wire telephone, a public telephone, a pay telephone and a personal computer.

In another embodiment, the short-range communication uses an infrared communication standard (Infrared Data Association: IrDA).

In another embodiment, the prescribed signals are formatted according to an infrared communication standard (Infrared Data Association: IrDA).

In another embodiment of the present invention, a system, which provides a wire communication to a reception terminal, includes a mobile terminal having an IrDA (Infrared Data Association) module and a wire processing block having an IrDA access point configuring an IrDA interface together with the IrDA module and a wire processing block connecting a wire communication path to the IrDA interface wherein the wire communication path reaches the reception terminal.

In another embodiment, the mobile terminal further includes a controller controlling the IrDA module to configure the IrDA interface, requesting a service call for the wire communication to the IrDA access point via the configured interface, and controlling transmission/reception of user signals via the configured interface after a setup of the service call.

In another embodiment, signals transmitted/received via the configured interface are formatted according to an infrared communication standard (Infrared Data Association: IrDA). More preferably, the signals are either user signals or control signals. More preferably, the control signals include a signal making a request of a service call for the wire communication to the wire processing block from the mobile terminal and a signal from the wire processing block to the mobile terminal in response to the request of the service call. More preferably, the signal making the request for the service call to the wire processing block includes an identification number of the reception terminal.

In another embodiment, the user signals include voice signals corresponding to voices inputted by users of the mobile and reception terminals, respectively.

In another embodiment, the mobile terminal returns to a mode for a wireless communication to a mobile communication network after the wire communication to the reception terminal has been terminated.

In a on embodiment of the present invention, in providing a mobile terminal having a short-range communication module with a wire communication via a wire network, a method of providing the wire communication includes the steps of configuring an interface according to a short-range communication standard between a short-range communication access point provided to an end terminal of the wire network and the short-range communication module, making a request of a service call for the wire communication to the end terminal from the mobile terminal via the configured interface according to the short-range communication standard, allowing the end terminal to connect a wire communication path reaching the reception terminal of the wire network to the configured interface, completing a setup of the service call between the mobile terminal and the reception terminal, and transmitting/receiving user signals between the mobile terminal and the reception terminal.

In another embodiment, the short-range communication uses an infrared communication standard (Infrared Data Association: IrDA).

In another embodiment, an identification number of the reception terminal is used in making the request of the service call for the wire communication.

In another embodiment, the method further includes the step of releasing the service call set up between the mobile terminal and the reception terminal after completion of transmitting/receiving the user signals. More preferably, the mobile terminal returns to an operational mode for a wireless communication via a mobile communication network after the service call has been released.

In another embodiment, the end terminal sets up the wire communication path to the reception terminal using an identification number of the reception terminal provided from the mobile terminal that makes the request for in case of making the request of the service.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a communication system through a wire network using an IrDA phone;

FIG. 2 is a diagram of a protocol architecture of an IrDA phone according to the present invention;

FIG. 3 is a block diagram of a system according to one embodiment of the present invention;

FIG. 4 is a flowchart of an operational method in an IrDA phone for a wire communication according to one embodiment of the present invention; and

FIG. 5 is a flowchart of an operational method in an IrDA access point (AP) and an end terminal for a wire communication according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A mobile communication terminal according to the present invention supports a wireless communication to a mobile communication network, and more particularly, a short-range wireless communication for a wire communication to a wire network (hereinafter, it is assumed that the wire network includes Internet.) Hence, the mobile communication terminal includes a short-range wireless communication module. The mobile communication terminal also communicates with a wire communication instrument (e.g., wire telephone, public telephone, pay telephone, personal computer, etc.) via the short-range wireless communication module. In this case, the wire communication instrument supports a wire communication through a wire network and includes the same short-range communication module of the mobile communication terminal.

An exemplary IrDA system for short-range wireless communication in accordance with the present invention is explained as follows.

A mobile communication terminal according to the present invention includes an IrDA interface module to support a wire communication to a wire network. Hence, the mobile communication terminal is referred to herein as an IrDA phone. The IrDA interface module is basically connected to an IR port as an external wireless communication path.

An apparatus, which interoperates with the IrDA phone, is an IrDA access point (AP) provided to an end terminal of the wire network. In this case, the IrDA AP includes an IrDA interface module to configure an IrDA interface together with that of the IrDA phone.

In the following description, the present invention is explained with one system structure including the IrDA phone and the IrDA AP.

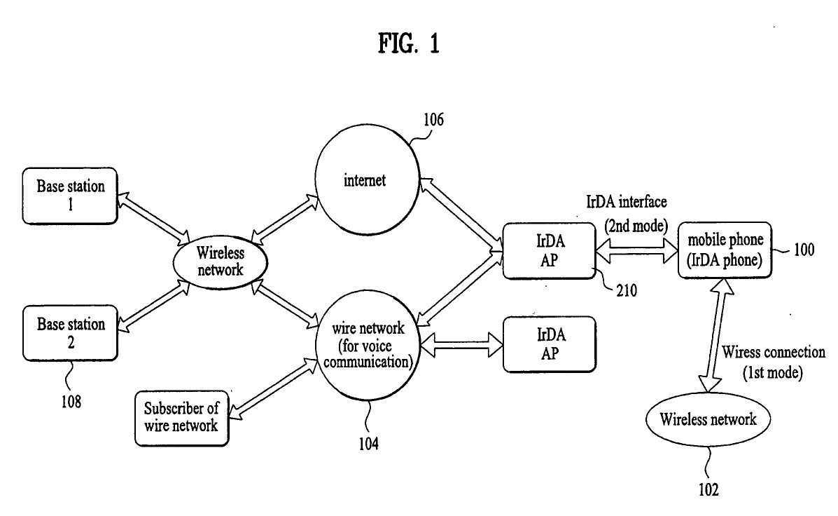

FIG. 1 is a block diagram of a communication system through a wire network using an IrDA phone. Referring to FIG. 1, a system includes an IrDA phone 100 supporting a wireless communication and having an IrDA interface module for a wire communication and an IrDA AP (access point) 210 having another IrDA interface module to support the wire communication of the IrDA phone 100.

The IrDA phone 100 configures an IrDA interface together with the IrDA AP 210 to perform a communication to a wire network 104 via the configured IrDA interface. In particular, the IrDA interface is configured between the IrDA interface module of the IrDA phone 100 and the IrDA interface module of the IrDA AP 210.

The IrDA phone 100 preferably operates in a first mode for the wireless communication to a mobile communication network or in a second mode for the wire communication to the wire network 104. The first mode of the IrDA phone 100 is configured for wireless communication, while the second mode is configured for wire communication. The IrDA phone 100 operating in the first mode supports a data and voice service via a wireless connection to a wireless network 102. For instance, in one embodiment, the wireless network 102 is a mobile communication network.

The IrDA phone 100 operating in the second mode supports a voice communication to the wire network 104 via a short-range wireless connection (IrDA interface) to the IrDA AP 210.

The following is a description of an IrDA phone 100 operating in the first mode. An IrDA phone 100 in the first mode establishes the wireless connection to the wireless network 102 via a base station and then provides the data and voice service.

The following is a detailed description of an IrDA phone 100 operating in the second mode. An IrDA AP 210 is provided to an end terminal (e.g., wire telephone, public telephone, pay telephone, personal computer, etc.) connected to the wire network 104.

In the second mode, the IrDA phone 100 configures the IrDA interface together with the IrDA AP 210 to be connected to the wire network 104 via the configured IrDA interface. In this case, the IrDA interface is configured between the IrDA interface module provided to the IrDA phone 100 and the IrDA interface module that is provided to the IrDA AP 210.

Hence, the system according to the present invention provides a wire communication service (Internet service 106, data & voice service, etc.) via the IrDA interface between the IrDA phone 100 in the second mode and the IrDA AP 210.

A user attempting to use the voice service via the wire network in the system according to the present invention accesses the end terminal provided with the IrDA AP 210 using the IrDA phone 100 in the second mode. After the IrDA interface between the IrDA phone 100 and the IRDA AP 210 has been established, the IrDA phone 100 plays the role of an end terminal. Namely, the user pages a reception terminal (a terminal possessed by a subscriber 108 of the wire network 104) using keys of the IrDA phone 100. The user inputs his voice via a voice input/output means (microphone and speaker) of the IrDA phone 100 and listens to a voice of a counter party.

Thus, the user uses a public telephone service (or pay telephone service) to the wire network 104 using the IRDA phone 100 operating in the second mode.

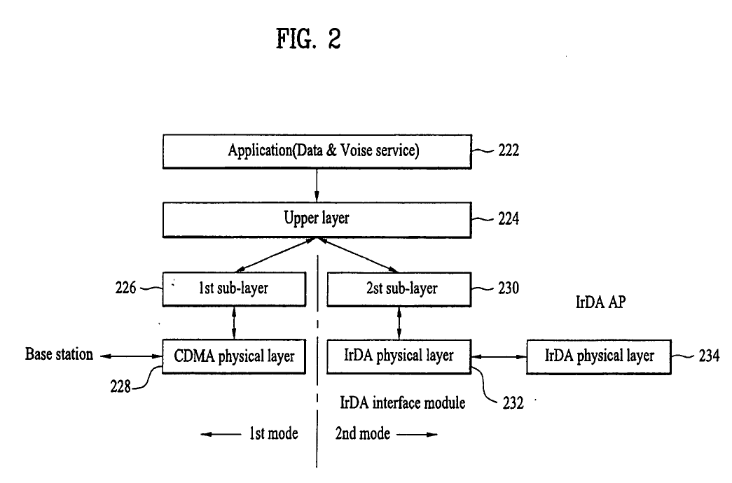

FIG. 2 is a diagram of a protocol architecture of an IrDA phone according to the present invention. Referring to FIG. 2, a protocol configuration of an IrDA phone according to the present invention is identified according to an operational mode of the IrDA phone. The IrDA phone selectively supports a wireless communication according to a first mode or a wire communication according to a second mode.

Where a user attempts to use a general wireless communication service, the IrDA phone operates in the first mode. Where a user attempts to use a wire communication service, the IrDA phone operates in the second mode.

An application layer 222 provides a data & voice service to enable the user of the IrDA phone to access a communication environment.

An upper layer 224 defines a data format to be used in the wire or wireless communication according to the data & voice service. The upper layer 224 provides a function of converting or selecting the used data format. In particular, the upper layer 224 decides what kind of communication system will be used for the data & voice service according to a user's setup. Namely, the upper 224 layer decides whether the data & voice service will be provided via the wire or wireless communication. In brief, the upper layer 224 is a layer to decide the operational mode of the IrDA phone.

In one embodiment, the system utilizes CDMA (code division multiple access) as the wireless communication protocol. In one embodiment, an IrDA system is used as the wire communication mechanism.

If the first mode is selected by the upper layer 224, a first sub-layer 226 and a CDMA physical layer 228 are activated. The first sub-layer 226 performs various functions on the user signals and user data, including error control, a speed control, flow control, and the like, according to the data & voice service.

The CDMA physical layer 228 transmits the user signals (or, user data) via a physical medium, i.e., a physical channel, and vice versa. In this case, the physical channel is a wireless channel.

On the other hand, if the second mode is selected by the upper layer 224, a second sub-layer 230 and an IrDA physical layer 232 are activated. Similar to the first sub-layer 226, the second sub-layer 230 performs various operations on the user signals and user data, including speed control, flow control, and the like, according to the data & voice service.

The IRDA physical layer 232 transmits the user signals (or, user data) via a physical medium, i.e., via a physical channel by the IrDA interface, and vice versa. In this case, the IrDA physical layer 232 is a layer corresponding to the IrDA interface module provided to the IrDA phone. The IrDA physical layer 232 is defined in the IrDA AP as well. And, the IrDA physical layer of the IrDA AP 234 is a layer corresponding to the IrDA interface module of the IrDA AP. Hence, the IrDA interface means a connection between the IrDA physical layer 232 of the IrDA phone and the IrDA physical layer of the IrDA AP 234.

Configurations and operations of the IrDA phone and the IrDA AP are explained in detail based on the above-explained protocol architecture as follows.

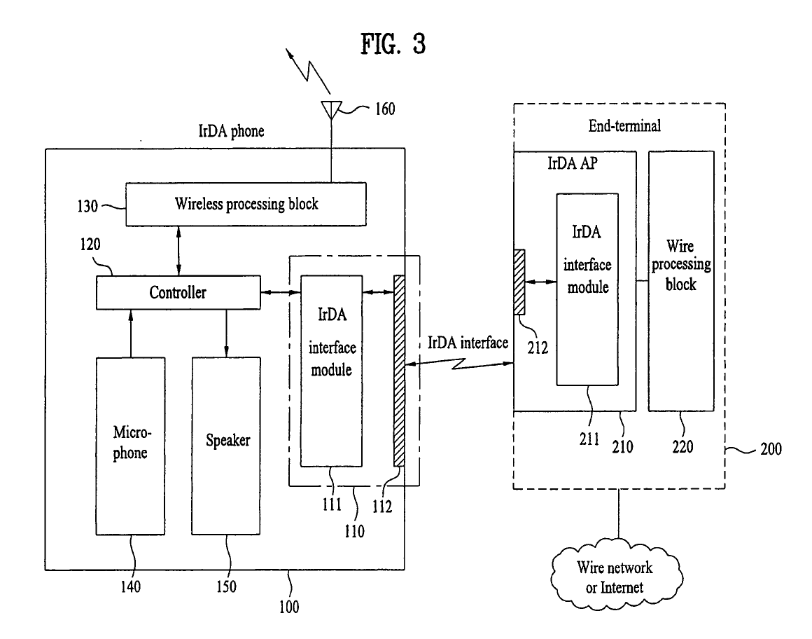

FIG. 3 is a block diagram of an exemplary system according to one embodiment of the present invention, in which a voice service is supported via a wire network. Referring to FIG. 3, a system according to the present invention includes an IrDA phone 100 and an IrDA AP 210.

The IrDA AP 210 is installed at an end terminal (e.g., wire telephone, public telephone, pay telephone, personal computer, etc.) 200 connected to a wire network. The IrDA phone 100 includes an IrDA block 110, a controller 120, a wireless processing block 130 and a voice input/output means. In this case, the IrDA block 110 includes an IrDA interface module 111 and an IrDA port 112. The voice input/output means includes a microphone 140 as a voice input means and a speaker 150 as a voice output means.

The controller 120 corresponds to upper layer 224 of FIG. 2. The controller 120 determines an internal signal path according to the operational mode of the IrDA phone and performs quality control of user signals (or, user data). The controller 120 further performs coding or decoding on the user signals (or, user data).

When operating in the first mode, the controller 120 configures a wireless signal path to the wireless processing block 130. Hence, the wireless processing block 130 converts low frequency signals received from the controller 120 to an RF signal. Similarly, wireless processing block 130 converts an RF signal received via an antenna 160 to a low frequency signal to transfer to the controller 120. The wireless processing block 130 controls the signal transmission/ reception with a base station of a wireless network.

When operating in the second mode, the controller 120 configures a wire signal path to the IrDA block 110. Hence, the IrDA interface module 111 of the IrDA block 110 transmits the transmission signal received from the controller 120 via the IrDA port 112 and transfers a reception signal received via the IrDA port 112 to the controller 120.

In case of supporting a voice communication service, the signal is a control signal for establishing a service call or a user's voice signal.

Prior to the transmission/reception of the signal, the IrDA interface module 111 of the IrDA phone 100 and the IrDA interface module 211 of the IrDA AP 210 configure an IrDA interface. The IrDA interface and the transmission/reception of the signal may be controlled by the controller 120.

Once the IrDA interface is activated, the controller requests a prescribed communication service call to the IrDA AP 210 via the IrDA interface. If an affirmative response is received from the IrDA AP 210, the controller 120 delivers voice data received via the microphone 140 via the currently setup signal path or a signal inputted via the setup signal path to the speaker 150. In doing so, the IrDA interface module 111 converts a voice signal inputted from the controller 120 to an IrDA format signal to transmit via the IrDA port 112 or converts an IRDA format signal received via 4 the IrDA port 112 to a voice signal to deliver to the controller 120.

A completion of the communication service call is explained in detail as follows. First a user operates a key to input an identification number of a reception terminal (not shown in the drawing). Then, the controller 120 may set up a wire signal path to the IrDA block 110. The controller 120 then transmits a control signal including the identification number of the reception terminal to the IrDA AP 210 via the IrDA interface.

The IrDA AP 210 interoperates with the wire processing block 220 of the end terminal 200 to set up the service call with the reception terminal (not shown in the drawing).

To support the voice service via the wire network, the end terminal 200 may include a means for coding a received voice for transmission via the wire network. Similarly, the end terminal 200 may include a means for decoding a signal received from the wire network for an external output.

The end terminal 200 of the present invention includes the wire processing block 220 for transferring the voice signal received from the wire network to the IrDA AP 210 and transmitting the voice signal to the wire network.

The IrDA interface module 211 of the IrDA AP 210 converts the signal received from the wire processing block 220 to the IrDA format for transmission via the IrDA port 212 and converts the IrDA format signal received via the IrDA port 212 to the voice signal to deliver to the wire processing block 220.

Prior to the above-explained signal transmission/ reception, if the voice communication to the wire network is requested, the wire processing block 220 may set up a service call for the voice communication from the end terminal 200 to the reception terminal (not shown in the drawing). In particular, the wire processing block 220 receives the control signal including the identification number of the reception terminal from the IrDA phone 100 and then establishes a wire communication path reaching the reception terminal using the identification number of the reception terminal.

Hence, if the voice communication up to the reception terminal (not shown in the drawing) of the wire network makes a request, the wire processing block 220 may set up the communication path for voice communication with the reception terminal. The wire processing block 220 connects the wire communication path according to the setup voice communication service call to the IrDA interface configured between the IRDA interface module 211 of the IrDA AP 210 and the IrDA block 110 of the IrDA phone 100. In this embodiment, the wire communication path according to the service setup of the wire processing block 220 may include a user-signals transfer path formed between the wire processing block 220 and the reception terminal.

A method for supporting the voice communication via the wire network in the IrDA phone 100, according to the above explained embodiment, is explained as follows.

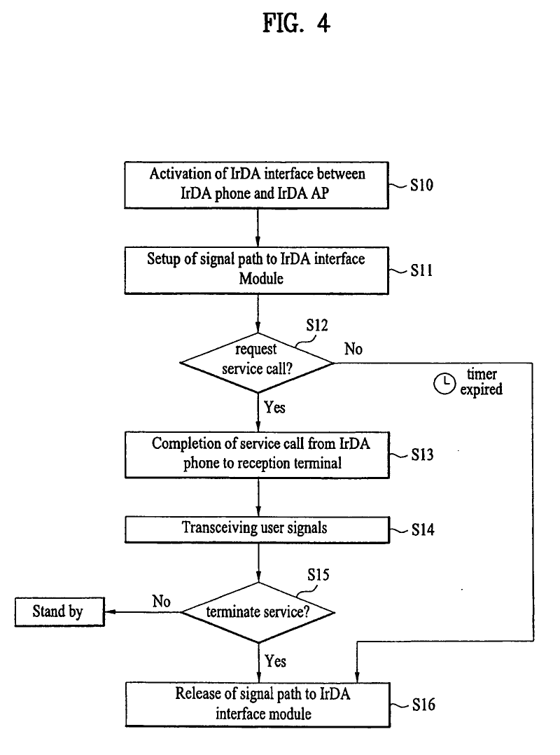

FIG. 4 is a flowchart of an operational method in an IrDA phone for a wire communication according to one embodiment of the present invention. The flowchart of the FIG. 4 embodiment illustrates an IrDA phone operating in the second mode.

As the IrDA phone is situated within a short-range communication range of an end terminal, an IrDA AP detects the presence of an IrDA phone. Hence, at S10, an IrDA interface is activated between the IrDA phone and the IrDA AP. Once the IrDA interface is activated, the IrDA phone sets up a signal path to an IrDA interface module at S11.

At S12, the IrDA phone determines whether a request for a communication service call is made by a user. Namely, the IrDA phone determines whether the user requests a voice communication by operating keys.

If it is decided that the request for the communication call has been made, the IrDA phone transmits a control signal for requesting the communication service call to the IrDA AP using the reception terminal identification as was inputted by the user. In this embodiment, the control signal transmitted/received via the IRDA interface is an IrDA format signal.

Having received an affirmative response to the service call request from the IrDA AP, the IrDA phone completes the communication service call to the reception terminal at S13. If there is no request of the communication service call until a timer expires, the IrDA phone releases the signal path to the IrDA interface module at S16.

Meanwhile, as the communication service call from the IrDA phone to the reception terminal is completed, at S14 the IrDA phone transmits user signals (data or voice signal) to the IrDA AP via the IrDA interface and receives user signals (data or voice signal) from the IrDA AP via the IrDA interface. In this embodiment, the user signals that are transmitted/received via the IrDA interface are IrDA format signals.

After completion of the transmission/reception of the user signals, i.e., after completion of the voice communication service at S15, the IrDA phone transmits a control signal informing the IrDA AP of the terminated service, and at S16, releases the signal path to the IrDA interface module. Thereafter, the IrDA interface between the IrDA phone and the IrDA AP is deactivated.

A method for supporting a voice communication between the IrDA AP 210 and the end terminal 200 according to the present invention is explained as follows.

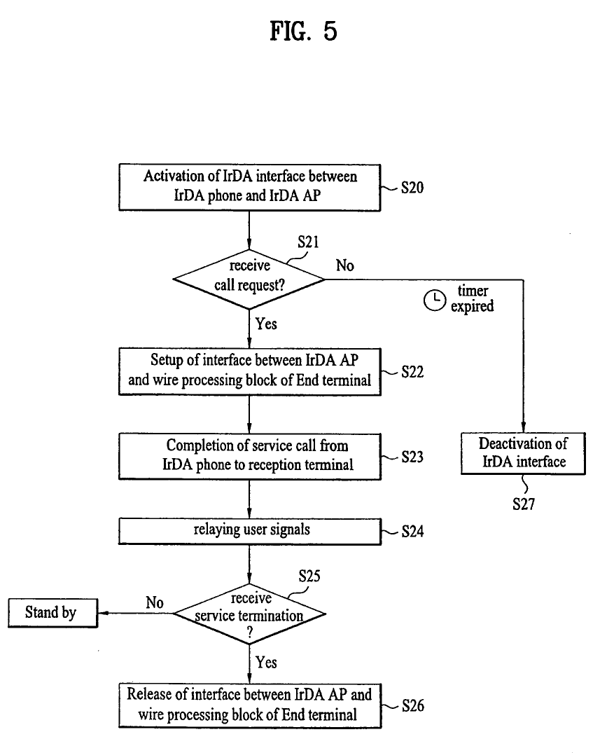

FIG. 5 is a flowchart of an operational method in an IrDA AP and an end terminal for a wire communication according to one embodiment of the present invention. Referring to FIG. 5, an IrDA phone operating in the second mode is situated within short-range communication proximity. An IrDA AP activates an IrDA interface between the IrDA phone and the IrDA AP at S20.

The IrDA AP delivers a signal received via the activated IrDA interface to an end terminal. At S21, the end terminal determines whether the signal received from the IrDA AP is a control signal for a communication service call request of the IrDA phone.

If the control signal is received from the IrDA AP, the end terminal preferentially sets up an interface between the IrDA AP and a wire processing block at S22. Subsequently, the wire processing block sets up a service call to the reception terminal with reference to the received control signal. If the control signal for the communication service call request or any call is not received until a timer expires, the IrDA AP deactivates the IrDA interface at S27.

Once the service call from the end terminal to the reception terminal of the wire network is completed, the end terminal transmits an affirmative response for the service call request to the IrDA phone. Hence, the communication service call to the reception terminal from the IrDA Phone is completed at S23.

The end terminal relays user signals (data or voice signal) between the IrDA phone and the reception terminal. In particular, at S24, the IrDA AP relays the user signals (data or voice signal) between the IrDA phone and the reception terminal S24. If the user signals (data or voice signal) are received from the wire processing block, the IrDA AP converts the received signal to an IrDA format signal to transmit to the IrDA phone. Where an IrDA format signal was received from the IrDA phone, the IrDA AP converts the received IrDA format signal to user signals (data or voice signal) to deliver to the wire processing block of the wire network.

IF a control signal is received from the IrDA phone at S25 indicating the termination of service, the end terminal releases the interface between the IrDA AP and the wire processing block at S26. Hence, the IrDA interface between the IrDA phone and the IrDA AP is deactivated as well.

In one embodiment of the present invention, if the IrDA phone is operating in the second mode, the IrDA phone may notify the corresponding event (i.e., the use event of wire communication service) to a serving base station of a mobile communication network via a radio channel so as to avoid a repetition of the service. In this embodiment, the serving base station sets a radio communication service for the corresponding IrDA phone to ‘unavailable’. The serving base station is a base station that can support the radio communication service to the current IrDA phone.

In another embodiment, when the wire communication service of an IrDA phone operating in the second mode with the wire network is terminated, the IrDA phone automatically returns to the first mode operation.

In another embodiment or the present invention, the wire communication service to the wire network may be a data or Internet service instead of the voice service.

Accordingly, the present invention increases efficiency of wire and wireless resources. Namely, the present invention mitigates the shortage of wireless channels for the mobile communication service and the reduction of the wire channels for the wire communication service by mutual compensation. In other words, the present invention relieves the shortage of wireless channels caused by user's communication by increasing the use of a wire network as an alternative plan for the wireless channel shortage.

For instance, if the radio communication environment is so poor as to not support the use of mobile communication with the IRDA phone, the present invention supports a real-time data & voice service via the wire network using the end terminal (e.g., wire telephone, public telephone, pay telephone, personal computer, etc.), having an IrDA AP on the wire network as a relay means. Specifically, the IrDA phone may automatically enter the second mode if the IrDA interface between the IrDA phone and the IrDA AP installed at the end terminal is activated.

Moreover, the present invention enables a user to download a massive volume of files from the wire network (e.g., Internet). This feature may be employed for a variety of purposes, including the download of program updates and installation for the operation of the IrDA phone. Hence, the present invention enables the corresponding download service to be provided at relatively high speed, regardless of a delay caused by the load on the wireless network.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile communication terminal, which supports a wire communication to a reception terminal of a wire network via an end terminal of the wire network, the end terminal having a short-range wireless communication access point, the mobile communication terminal comprising:
a communication module configured to provide short-range wireless communication with the short-range wireless communication access point; and
a controller setting up a wire signal path to the communication module for transmission and reception of signals via the communication module.

2. The mobile communication terminal of claim 1, wherein the short-range wireless communication uses an infrared communication standard of the Infrared Data Association (IrDA).

3. The mobile communication terminal of claim 1, wherein the signals are formatted according to an infrared communication standard of the Infrared Data Association (IrDA).

4. The mobile communication terminal of claim 1, wherein the signals include control signals for setting up a service call to the reception terminal and user signals transmitted/received after a setup of the service call.

5. The mobile communication terminal of claim 1, wherein an event of the wire communication to the reception terminal is notified to a serving base station supporting a wireless communication of the mobile communication terminal.

6. An apparatus for supporting a short-range wireless communication with a mobile communication terminal, and for providing a wire communication to a reception terminal on a wire network, comprising:
a short-range communication access point having a short-range communication module configured for supporting the short-range wireless communication between the mobile communication terminal and the short-range communication access point and to interface between the short-range wireless communication and the wire communication; and
a wire processing block for establishing a wire communication path to the reception terminal.

7. The apparatus of claim 6, wherein the short-range communication access point delivers user signals received from the mobile communication terminal to the wire processing block, and wherein the short-range communication access point transmits user signals received from the reception terminal via the wire processing block to the mobile communication terminal.

8. The apparatus of claim 7, wherein the wire processing block transmits the user signals received from the mobile communication terminal via the short-range communication access point to the reception terminal, and wherein the wire processing block delivers the user signals received from the reception terminal to the short-range communication access point.

9. The apparatus of claim 6, wherein the apparatus is installed at an end terminal of the wire network.

10. The apparatus of claim 9, wherein the end terminal comprises one selected from the group consisting of a wire telephone, a public telephone, a pay telephone and a personal computer.

11. The apparatus of claim 6, wherein the short-range wireless communication uses an infrared communication standard of the Infrared Data Association (IrDA).

12. The apparatus of claim 6, wherein user signals are formatted according to an infrared communication standard of the Infrared Data Association (IrDA).

13. A system, which provides a wire communication to a reception terminal, the system comprising:
a mobile terminal having an Infrared Data Association (IrDA) module; and
a wire communication terminal having an IrDA access point for providing an IrDA interface with the IrDA module, and a wire processing block for establishing a wire communication path from the IrDA access point to the reception terminal.

14. The system of claim 13, the mobile terminal further comprising a controller for controlling the configuration of the IrDA interface between the IrDA module and the IrDA access point, the controller also for controlling the request of a service call, and for controlling transmission/reception of user signals via the IrDA interface after a setup of the service call.

15. The system of claim 13, wherein signals transmitted/received via the IrDA interface are formatted according to an infrared communication standard of the Infrared Data Association (IrDA).

16. The system of claim 15, wherein the signals are either user signals or control signals.

17. The system of claim 16, wherein the control signals include a service call request signal from the mobile terminal to the wire communication terminal and a service call response signal from the wire communication terminal to the mobile terminal.

18. The system of claim 17, wherein the service call request signal includes an identification number of the reception terminal.

19. The system of claim 16, wherein the user signals include voice signals corresponding to voices inputted by users of the mobile and reception terminals.

20. The system of claim 13, wherein the mobile terminal returns to a mode for a wireless communication to a mobile communication network after the wire communication to the reception terminal has been terminated.

21. In a mobile terminal having a short-range communication module for communicating with an end terminal of a wire network, a method of providing wire communication, comprising:
configuring an interface according to a short-range communication standard between a short-range communication access point of the end terminal of the wire network and the short-range communication module;
making a service call request for the wire communication to the end terminal from the mobile terminal via the configured interface according to the short-range communication standard;
connecting a wire communication path reaching the reception terminal of the wire network to the configured interface;
completing a setup of the service call between the mobile terminal and the reception terminal; and
transmitting and receiving user signals between the mobile terminal and the reception terminal.

22. The method of claim 21, wherein the short-range communication uses an infrared communication standard of the Infrared Data Association (IrDA).

23. The method of claim 21, wherein an identification number of the reception terminal is used in making the service call request for the wire communication.

24. The method of claim 21, further comprising the step of releasing the service call set up between the mobile terminal and the reception terminal after completion of transmitting and receiving of the user signals.

25. The method of claim 24, further comprising returning the mobile terminal to an operational mode for wireless communication via a mobile communication network after the service call has been released.

26. The method of claim 21, wherein the end terminal sets up the wire communication path to the reception terminal using an identification number of the reception terminal provided from the mobile terminal that makes the request.
